(19) United States
(12) Patent Application Publication
(10) Pub. No.: US 2004/0181961 A1
(43) Pub. Date: Sep. 23, 2004

(54) Handler for testing semiconductor device

(75) Inventors: Ji Hyun Hwang, Seongnam-shi (KR); Gil Ho Bae, Chinhae-shi (KR); Hyun Joo Hwang, Uiwang-shi (KR); Sang Jeon Park, Seongnam-shi (KR); Hyun Joon Cho, Seongnam-shi (KR); Seung Hwan Kim, Chonan-shi (KR); In Hee Oh, Seongnam-shi (KR); Yon Choul Baek, Seoul (KR); Young Mi Choi, Seongnam-shi (KR); Sung Hoe Kim, Yongin-shi (KR); Jae Myeong Song, Seongnam-shi (KR)

Correspondence Address: FLESHNER & KIM, LLP, P.O. Box 221200, Chantilly, VA, 20153-1200, US

(73) Assignee: Mirae Corporation

(21) Appl. No.: 10/377,657

(22) Filed: Mar. 4, 2003

(51) Int. Cl. F26B 13/30

(52) U.S. Cl. 34/92

(57) ABSTRACT

A handler for testing semiconductor devices is provided, wherein a soaking plate is fitted on a handler body having temperature control means for heating and/or cooling semiconductor devices placed thereon. Loading/unloading shuttles are movably fitted, such that they can move in a forward/backward direction, for carrying the semiconductor deices to/from a test site, thereby simplifying a handler system and permitting accurate temperature testing under in high or low temperature environments.

### BACKGROUND OF THE INVENTION

1. Field of the Invention

The present invention relates to a handler for testing semiconductor devices and, more particularly, to a handler for testing semiconductor devices, which permits room, or high temperature testing of semiconductor devices while the semiconductor devices are moved horizontally between fabrication processes.

2. Background of the Related Art

In general, semiconductor devices, fabrication of which are finished on a production line, undergo testing before shipment for defects. A horizontal type handler automatically transfers devices in a tray in a horizontal direction between processes so that the devices can be fitted to respective test sockets at a test site, subjected to required tests, classified in various classes, and unloaded on trays.

Semiconductor devices are now being used in more diverse environments. Thus, semiconductor devices need to be tested in a variety of environments, and semiconductor device handlers are needed that can provide the environments needed for carrying out semiconductor tests at required temperatures.

### SUMMARY OF THE INVENTION

An object of the invention is to solve at least the above problems and/or disadvantages and to provide at least the advantages described hereinafter.

An object of the present invention is to provide a handler for testing semiconductor devices, which has a simple structure, but permits fast and accurate testing, not only at room temperature, but also at a high or low temperatures.

To achieve these and other advantages and in accordance with the purpose of the present invention, as embodied and broadly described, there is provided a handler for transporting semiconductor devices to and from a predetermined area, including a loading area for holding semiconductor devices to be transported to the predetermined area, an unloading area for receiving semiconductor devices from the predetermined area, a temperature adjustment area for heating and/or cooling the semiconductor devices to a predetermined temperature, a first transporter for selectively transporting semiconductor devices to and/or from the loading area, temperature adjustment area, and unloading area, and a second transporter for selectively transporting the semiconductor devices to the predetermined area and transporting semiconductor devices from the predetermined area.

To achieve these and other advantages and in accordance with the purpose of the present invention, as embodied and broadly described, there is further provided a handler for transporting semiconductor devices to and from a testing station in a testing area, including a loading area for holding semiconductor devices to be tested, an unloading area for receiving tested semiconductor devices, a temperature adjustment area for selectively heating and/or cooling the semiconductor devices to be tested to a predetermined temperature prior to testing, at least one loading shuttle for transporting the semiconductor devices to be tested to the testing area, at least one unloading shuttle for transporting tested semiconductor devices from the testing area, a first picker for picking up and transporting the semiconductor devices to be tested from the loading area to the temperature adjustment area and/or the at least one loading shuttle, and a second picker for picking up and transporting the tested semiconductor devices from the at least one unloading shuttle to the unloading area.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 4 is a schematic plan view of a handler, in accordance with a first preferred embodiment of the present invention; and

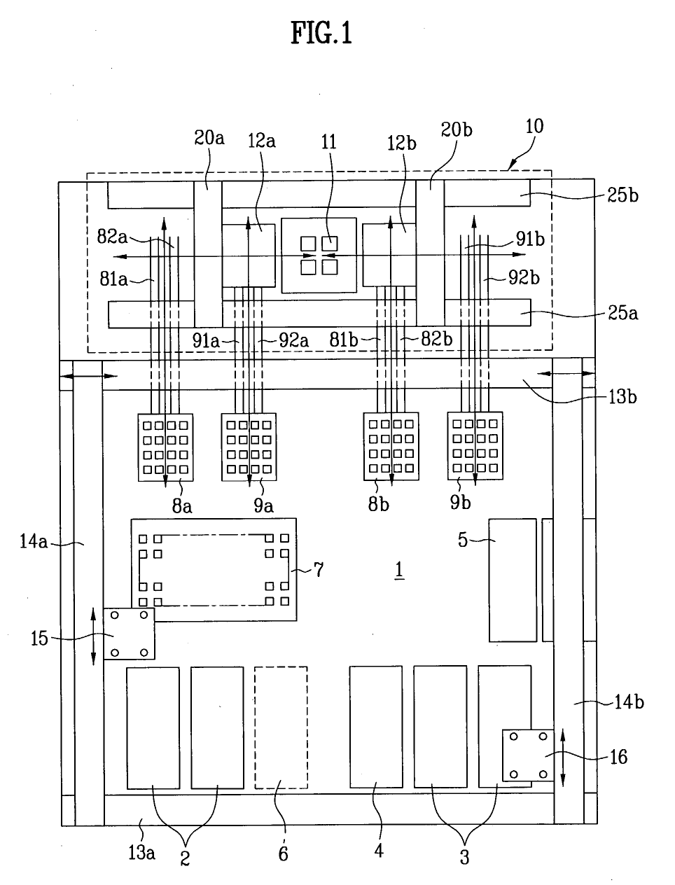

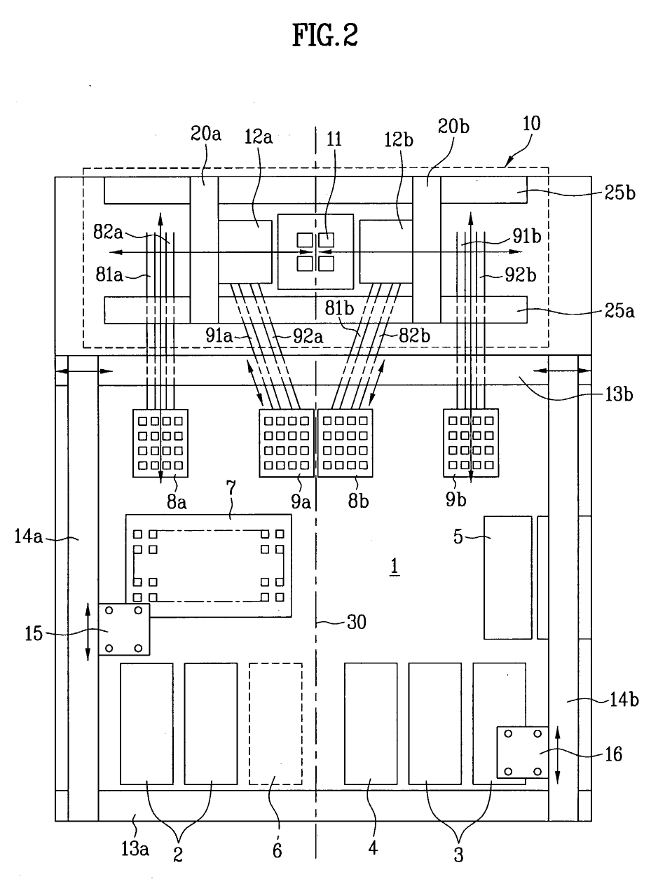

FIG. 2 is a schematic plan view of a handler, in accordance with a second preferred embodiment of the present invention.

### DETAILED DESCRIPTION OF PREFERRED EMBODIMENTS

Reference will now be made in detail to the preferred embodiments of the present invention, examples of which are illustrated in the accompanying drawings.

FIG. 1 is a schematic plan view of a handler, in accordance with a first preferred embodiment of the present invention.

Referring to FIG. 1, in a front part of the handler 1, there are loading stackers 2 for stacking trays that hold the semiconductor devices to be tested, and unloading stackers 3 for stacking trays that hold semiconductor devices classified “good” as a result of the testing. At the rear of the loading stackers 2, there is a soaking plate 7 having temperature control means (not shown), such as heating means (not shown) and/or cooling means (not shown). The soaking plate 7 receives the semiconductor devices to be tested from the loading stackers 2, and heats and/or cools the semiconductor devices for temperature testing.

A tray stacker 6 is located on one side of the loading stackers 2 for stacking trays that have been emptied as a result of the semiconductor devices being transferred to the soaking plate for testing. A retest stacker 4 and a reject stacker 5 are located on one side and to the rear of the unloading stackers 3, respectively. The retest stacker 4 is used for stacking trays that hold semiconductor devices classified as retest products during the test. The reject stacker is used for stacking trays that hold semiconductor devices determined to be defective.

At the rear of the handler body 1, there is a test site 10 having test sockets 11 for providing an electrical connection to an external test apparatus for testing the semiconductor devices. A first loading shuttle 8a and a second loading shuttle 8b are each movably fitted such that they can move in a forward/backward direction. The first and second loading shuttles 8a and 8b are adapted to receive the semiconductor devices from the loading stacker 2 or the soaking plate 7, and deliver the semiconductor devices to both sides of the test sockets 11 in the test site 10.

A first unloading shuttle 9a and a second unloading shuttle 9b are each movable fitted such that they can move in a forward/backward direction. The first and second unloading shuttles 9a and 9b are preferably movably fitted on one side of the first loading shuttle 8a and on one side of the second loading shuttle 8b, respectively, and are adapted to receive the semiconductor devices tested at the test site 10 and transport them out of the test site 10.

The loading shuttles 8a and 8b and the unloading shuttles 9a and 9b are fitted to linear movement (LM) guides 81a, 81b and 91a, 91b, respectively, and LM blocks (not shown) that are mounted on the handler body along a front/rear axis. The loading shuttles 8a and 8b and the unloading shuttles 9a and 9b are also coupled to movers (not shown) of linear motors 82a, 82b and 92a, 92b, respectively, that are respectively fitted in parallel to the AM guides 81a, 81b and 91a, 91b. Thus, the loading shuttles 8a and 8b and the unloading shuttles 9a and 9b can move along the LM guides 81a, 81b and 91a, 91b in a forward/backward direction under the force provided by linear motors 82a, 82b, 92a, 92b, respectively.

In addition, temperature control means, such as heating means (not shown) and/or cooling means (not shown) are preferably fitted in each of the first and second loading shuttles 8a and 8b for heating and/or cooling the semiconductor devices seated thereon, and for sustaining a temperature of the semiconductor devices while the semiconductor devices, which were pre-heated/pre-cooled at the soaking plate 7, are transported to the test site 10.

Fixed frames 13a and 13b cross over a front end of the handler body 1 and a front part of the test site 10, and one pair of movable frames 14a and 14b are fitted to the fixed frames 13a and 13b and are movable along the fixed frames 13a and 13b in left/right directions. A loading picker 15 and an unloading picker 16 are fitted to and are movable along the movable frames 14a and 14b, respectively.

A first index head 12a and a second index head 12b are movably fitted so that they can move horizontally over the test socket 11 of the test site 10 for carrying and fitting the semiconductor devices from the first and second loading shuttles 8a and 8b, respectively, to the test socket 11, and for carrying the semiconductor devices from the test socket 11 to the first and second unloading shuttles 9a and 9b, respectively. In a preferred embodiment, the first and second index heads 12a and 12b are each movably fitted by mounting them on movable frames 20a and 20b, respectively. The movable frames 20a and 20b are attached to fixed frames 25a and 25b. This preferred configuration allows the first and second index heads 12a and 12b to move independently of each other.

The first and second index heads 12a and 12b preferably press down on the semiconductor devices at a predetermined pressure while the semiconductor devices are attached to the socket 11 and tested. In a preferred embodiment, the first and second index heads 12a and 12b are provided with temperature control means, such as heating means (not shown) and/or cooling means (not shown) for sustaining a desired temperature while the semiconductor devices are tested.

The loading shuttles 8a and 8b, the unloading shuttles 9a and 9b, the movable frames 14a and 14b, the loading picker 15, the unloading picker 16, and the index heads 12a and 12b may all be adapted for linear motion by using any means known in the art, including, but not limited to, using guide members and driving means, such as the LM guide, the linear motors, or ball screws and servo-motors, and the like.

FIG. 2 is a schematic plan view of a handler, in accordance with a second preferred embodiment of the present invention. Referring to FIG. 2, the handler 1 includes LM guides 81b and 91a, and linear motors 82b and 92a for guiding movement of a second loading shuttle 8b and a first unloading shuttle 9a, respectively. LM guides 81a and 91b, and linear motors 82a and 92b are used to guide movement of the first loading shuttle 8a and the second unloading shuttle 9b, respectively. In the second preferred embodiment of FIG. 2, the loading shuttles 8a, 8b and unloading shuttles 9a, 9b are positioned such that the paths of travel of the loading picker 15 and the unloading picker 16 are shortened, and interference between them is reduced, thereby improving their workable ranges. This is preferably accomplished by positioning the first unloading shuttle 9a and the second unloading shuttle 8b such that, at a first position, they are located adjacent a centerline 30 of the handler, and such that a distance between them is minimized. In the embodiment of FIG. 2, the first unloading shuttle 9a and the first loading shuttle 8a are movably mounted such that they move in directions that are oblique with respect to each other, and such that a distance between them becomes smaller as they move towards the test site 10. Similarly, the second unloading shuttle 9b and the second loading shuttle 8b are movably mounted such that they move in directions that are oblique with respect to each other, and such that a distance between them becomes smaller as they move towards the test site.

As discussed above, this configuration shortens the paths of travel of the loading picker 15 and the unloading picker 16, minimizes interference between them, and results in an improvement in their workable ranges. This is because the configuration of FIG. 2 places the second loading shuttle 8b closer to the loading picker 15, and the first unloading shuttle 9a closer to the unloading picker 16. Therefore, the paths of travel of the loading picker 15 and the unloading picker 16 are shortened, and interference between them is minimized. In one preferred embodiment, the LM guides 81a, 81b, 91a and 91b are positioned such that they form an approximate “M”-shaped pattern when viewed from above the handler 1.

The operation of the foregoing handlers will now be explained. When it is intended to test a semiconductor device at high temperatures, upon putting the handler into operation once the trays containing the semiconductor devices to be tested are loaded on the loading stacker 2, the loading picker 15 picks up the semiconductor devices from the tray in the loading stacker 2, carries the semiconductor devices to the soaking plate 7, and places the semiconductor devices on the soaking plate 7. In this instance, since the soaking plate 7 has been heated/cooled to a predetermined temperature by the heating/cooling means therein, the semiconductor devices placed on the soaking plate 7 are also heated/cooled to the predetermined temperature.

When the semiconductor devices reach a desired temperature over a predetermined time period, the loading picker 15 picks up the semiconductor devices on the soaking plate 7, carries them to and places them on the first loading shuttle 8a and, once the first loading shuttle is full, the second loading shuttle 8b. In this instance, since the first and second loading shuttles 8a and 8b are also heated/cooled to a predetermined temperature by the heating means (not shown) therein, the first and second loading shuttles can also sustain the semiconductor devices at the desired test temperature.

The first and second loading shuttles 8a and 8b, having the semiconductor devices to be tested placed thereon, are moved to opposite sides of the test socket 11 in the test site 10 by linear motors 82a and 82b, respectively. In this instance, the first and second unloading shuttles 9a and 9b are also moved to opposite sides of the test socket 11 by linear motors 92a and 92b, respectively.

When the first, and second loading shuttles 8a and 8b are located on opposite sides of the test socket 11, the first and second index heads 12a and 12b come into operation in succession to pick up the semiconductor devices on the first and second loading shuttles 8a and 8b, respectively, and fit them to the test socket 11 for testing over a predetermined time period.

When the test is finished, the first and second index heads 12a and 12b carry the tested semiconductor devices to the first and second unloading shuttles 9a and 9b, respectively, and place the semiconductor devices thereon. Then, the first and second unloading shuttles 9a and 9b move to a position outside the test site 10, preferably their initial position. The semiconductor devices on the unloading shuttles 9a and 9b are sorted according to a result of the test, by the unloading picker 16, into good products, products to be retested, and defective products. The good products are carried to the unloading stackers 3 and placed on the tray, the products to be retested are carried to the retest stacker 4 and placed thereon, and the defective products are carried to the reject stacker 5 and placed on the tray.

When performing room temperature testing on the semiconductor devices, the semiconductor devices on the loading stackers 2 are transferred to the first and second loading shuttles 8a and 8b directly, without being placed on the soaking plate 7, and the heating means (not shown) in the first and second loading shuttles 8a and 8b are not activated. The remainder of the process is the same as that used when testing at temperatures other than room temperature.

As discussed above, the handler of the present invention for testing semiconductor devices permits, not only room temperature testing, but also a high temperature or a low temperature testing of semiconductor devices, thereby increasing the number of devices processed per unit time. In addition, standby times are reduced because two index heads 12a and 12b are provided.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A handler for transporting semiconductor devices to and from a predetermined area, comprising:
a loading area for holding the semiconductor devices to be transported to the predetermined area;
an unloading area for receiving semiconductor devices from the predetermined area;
a temperature adjustment area for selectively heating and/or cooling the semiconductor devices to a predetermined temperature;
a first transporter for selectively transporting semiconductor devices to and/or from the loading area, temperature adjustment area and the unloading area; and
a second transporter for selectively transporting the semiconductor devices to the predetermined area and transporting semiconductor devices from the predetermined area.

2. The handler of claim 1, wherein the loading area is adapted to hold stackable trays that contain the semiconductor devices to be transported to the predetermined area.

3. The handler of claim 1, wherein the temperature adjustment area comprises a soaking plate having a heater and/or cooler for selectively adjusting a temperature of the semiconductor devices to the predetermined temperature.

4. The handler of claim 1, wherein the first and second transporters each comprise a temperature maintainer for selectively maintaining the predetermined temperature of the semiconductor devices to be transported to the predetermined area.

5. The handler of claim 1, wherein the second transporter comprises at least one shuttle for transporting semiconductor devices to and from the predetermined area.

6. The handler of claim 5, wherein the first transporter comprises at least one picker for picking up and transporting the semiconductor devices to and/or from the loading area, the temperature adjustment area, the at least one shuttle and the unloading area.

7. The handler of claim 5, wherein the at least one shuttle comprises:
first and second loading shuttles for transporting the semiconductor devices to the predetermined area; and
first and second unloading shuttles for transporting the semiconductor devices from the predetermined area.

8. The handler of claim 7, wherein the first and second loading shuttles and the at least one picker each comprise a heater and/or a cooler for selectively maintaining the predetermined temperature of the semiconductor devices to be transported to the predetermined area.

9. The handler of claim 5, wherein the second transporter further comprises at least one index head for transporting the semiconductor devices between the at least one shuttle and a station in the predetermined area.

10. The handler of claim 9, wherein the at least one index head comprises a heater and/or a cooler for selectively maintaining the predetermined temperature of semiconductor devices picked up by the at least one index head.

11. The handler of claim 7, wherein a first one of the loading shuttles and a first one of the unloading shuttles are movably mounted such that, at a first position, a distance between them is minimized.

12. The handler of claim 11, wherein when the first ones of the loading and unloading shuttles are at the first position, they are located adjacent a centerline of the handler.

13. The handler of claim 7, wherein:
the first loading shuttle and the first unloading shuttle are movably mounted so that their transport paths are oblique with respect to each other; and
the second loading shuttle and the second unloading shuttles are movably mounted so that their transport paths are oblique with respect to each other.

14. The handler of claim 13, wherein:
the first loading and unloading shuttles are movably mounted so that they move towards each other when they move towards the predetermined area; and
the second loading and unloading shuttles are movably mounted so that they move towards each other when they move towards the predetermined area.

15. The handler of claim 13, further comprising at least one index head for transporting the semiconductor devices between the first and second loading shuttles, a testing station, and the first and second unloading shuttles.

16. The handler of claim 6, wherein the at least one shuttle and the at least one picker each comprises a heater and/or a cooler for selectively maintaining the predetermined temperature of the semiconductor devices to be transported to the predetermined area.

17. The handler of claim 15, wherein the at least one index head comprises a heater and/or a cooler for selectively maintaining the predetermined temperature of semiconductor devices picked up by the at least one index head.

18. The handler of claim 1, wherein the unloading area is adapted to hold stackable trays that contain semiconductor devices from the predetermined area.

19. The handler of claim 1, wherein the predetermined area comprises a testing area.

20. The handler of claim 19, wherein the unloading area is adapted to hold at least one tray for receiving tested semiconductor devices that fail a test, at least one tray for receiving tested semiconductor devices that pass a test, and at least one tray for receiving tested semiconductor devices that require retesting.

21. The handler of claim 6, wherein the at least one picker comprises:
a first picker for picking up and transporting the semiconductor devices from the loading area to the temperature adjustment area and/or the at least one shuttle; and
a second picker for picking up and transporting semiconductor devices from the at least one shuttle to the unloading area.

22. A handler for transporting semiconductor devices to and from a testing station in a testing area, comprising:
a loading area for holding semiconductor devices to be tested;
an unloading area for receiving tested semiconductor devices;
a temperature adjustment area for selectively heating and/or cooling the semiconductor devices to be tested to a predetermined temperature prior to testing;
at least one loading shuttle for transporting the semiconductor devices to be tested to the testing area;
at least one unloading shuttle for transporting tested semiconductor devices from the testing area;
a first picker for picking up and transporting the semiconductor devices to be tested from the loading area to the temperature adjustment area and/or the at least one loading shuttle; and
a second picker for picking up and transporting the tested semiconductor devices from the at least one unloading shuttle to the unloading area.

23. The handler of claim 22, wherein the at least one loading shuttle comprises a heater and/or a cooler for selectively maintaining the predetermined temperature of the semiconductor devices to be tested.

24. The handler of claim 22, further comprising at least one index head for transporting the semiconductor devices to be tested from the at least one loading shuttle to the testing station and for transporting the tested semiconductor devices from the testing station to the at least one unloading shuttle.

25. The handler of claim 24, wherein the at least one index head comprises first and second index heads.

26. The handler of claim 25, wherein the first and second index heads are adapted to move independently of each other.

27. The handler of claim 24, wherein the at least one index head comprises a heater and/or a cooler for selectively maintaining the predetermined temperature of the semiconductor devices to be tested.

28. The handler of claim 22, wherein at least one loading shuttle and at least one unloading shuttle are movably mounted such that, at a first position, a distance between them is minimized.

29. The handler of claim 28, wherein when the at least one loading shuttle and the at least one unloading shuttle are at the first position, they are located adjacent a centerline of the handler.

30. The handler of claim 22, wherein at least one loading shuttle and at least one unloading shuttle are movably mounted so that their transport paths are oblique with respect to each other.

31. The handler of claim 30, wherein the at least one loading shuttle and the at least one unloading shuttle are movably mounted so that they move towards each other when they move towards the testing area.

32. The handler of claim 31, wherein the at least one loading shuttle comprises a heater and/or a cooler for selectively maintaining the predetermined temperature of the semiconductor devices.

33. The handler of claim 31, further comprising at least one index head for transporting the semiconductor devices to be tested from the at least one loading shuttle to the testing station and for transporting tested semiconductor devices from the testing station to the at least one unloading shuttle.

34. The handler of claim 33, wherein the at least one index head comprises first and second index heads.

35. The handler of claim 34, wherein the first and second index heads are adapted to move independently of each other.

36. The handler of claim 33, wherein the at least one index head comprises a heater and/or a cooler for selectively maintaining the predetermined temperature of the semiconductor devices to be tested.
